(19) United States
(12) Patent Application Publication
(10) Pub. No.: US 2007/0246092 A1
(43) Pub. Date: Oct. 25, 2007

(54) Retractable Rain Cover for a Golf Cart

(76) Inventors: William Gerrie, Webster, NY (US); Kenneth M. McAlpin, Webster, NY (US)

Correspondence Address: Stephen B. Salai, Esq.;Harter, Secrest & Emery LLP, 1600 Bausch & Lomb Place, Rochester, NY, 14604-2711, US

(21) Appl. No.: 11/743,098

(22) Filed: May 1, 2007

Related U.S. Application Data
(63) Continuation-in-part of application No. 10/753,240, filed on Jan. 8, 2004, now Pat. No. 7,210,492.

(51) Int. Cl. B60J 11/02

(52) U.S. Cl. 135/88.07

(57) ABSTRACT

A retractable rain cover for attachment to a golf cart includes a rigid frame, a canopy, and at least one closable opening. The golf cart has a roof including upper and lower layers defining an opening therebetween and a rear end portion adapted to support at least two side-by-side upright golf bags. The rigid open frame is attachable to a rear of the golf cart and includes two side members, one located on each side of the rear end portion of the golf cart. The canopy is carried by and extends between the two side members. The canopy is movable between a stowed position between upper and lower layers of the roof and a deployed position supported by the two side members of the frame. The canopy in the deployed position overlays the upper ends of the two side-by-side upright golf bags. The at least one closable opening within the canopy is located to align with the upper end of at least one of the two side-by-side upright golf bags when the canopy is in the deployed position.

### CROSS-REFERENCE TO RELATED APPLICATIONS

This application is a continuation-in-part of U.S. patent application Ser. No. 10/753,240, which issued on May 1, 2007, as U.S. Pat. No. 7,210,492.

### BACKGROUND OF THE INVENTION

1. Field of the Invention

The present invention relates generally to a protective canopy for attachment to a golf cart to protect the clubs in golf bags carried at the rear of a golf cart. More particularly, the present invention relates to such a canopy that is easily deployed in inclement weather and in the deployed position, allows easy access through the canopy to individual clubs in the golf bag.

2. Description of Related Art

It is not uncommon for golfers to use a golf cart while playing a round of golf. In fact, many golf courses require that the players use a golf cart in order to speed play. In a typical arrangement, the golf cart has seating to accommodate two players (a driver and a rider) and a rear rack to carry two golf bags side-by-side.

A golf cart generally has a rigid or fabric roof to protect the riders from both sun and rain. In the event of inclement weather, provision is made to protect the golf bags and particularly the golf clubs retained in the bag. For example, protective curtains at the rear of the cart can be unfurled from the sides of the golf cart. The ends of the curtains are brought together and closed over the golf bags to protect the clubs and the bags. In many cases a zipper or snaps that hold the curtains closed can be undone to permit access the clubs if play continues during rain.

Other protective systems include an awning arrangement wherein a canopy attached along the rear roofline of the golf cart can pivot down and over the heads of the golf clubs in the two golf bags. The canopy is raised to allow simultaneous access to the clubs in both bags.

While these protective systems accomplish the intended purpose of protecting the heads of the golf clubs in the bags, they suffer from several drawbacks. For example, some systems are clumsy and difficult to deploy. In others, access to the clubs is gained only by reversing the steps followed in deploying the covering. Another drawback is that once the protective canopy is deployed, access to the clubs in either of the bags carried at the rear of the cart requires that both golf bags be exposed to the elements.

Accordingly, it is an object of the present invention to provide a rain cover attachable to a golf cart wherein the rain cover is easily deployed in inclement weather.

Another object of the present invention is to provide a rain cover that is retracted as easily as it is deployed.

A further object of the present invention is to provide a retractable rain cover allows separate access to adjacent golf bags covered by a deployed rain cover.

### BRIEF SUMMARY OF THE INVENTION

In accordance with the present invention a retractable rain cover is provided that includes a generally open framework that is attachable to a golf cart. The frame is attachable to the roof support columns of the golf cart or to the roof itself or to both. The frame is fixed and has an aft end portion that extends rearward from the rear roofline of the cart and is sized to encompass at least the upper end portions of golf bags carried on a rear platform of the golf cart. In this respect the frame has structural elements that overlie a golf bag carried on the cart and extend below at least an upper portion of the bag. Preferably these structural elements of the aft end portion include a guide track for purposes set out hereinbelow.

The open framework supports a flexible canopy that is movable relative to the frame between a stowed position and a deployed position. The canopy normally is in its stowed position such that it is reefed or retracted relative to the aft end portion of the frame. When the canopy is stowed, open framework exposes the golf bags to the elements. In a stowed position the canopy may be rolled up on a reel that extends along the rear roofline of the cart. As an alternative, the stowed canopy can be in a stretched flat condition that lies within the footprint of the golf cart roof.

When rain protection is needed the canopy is deployed by unfurling it from the reel or extending it out from under the footprint of the cart roof. In its extended position, the canopy is coextensive with the portion of the frame that encompasses at least the top portions of the bags so it overlies the bags to provide a shelter for the golf clubs.

The canopy has two closable openings. When the canopy is deployed and overlies the golf bags at the rear of the golf cart, the two openings will align with the tops of the bags. Flaps secured by a hook and loop fastener, snap or other suitable fastener close the openings. Accordingly, when the canopy is in its extended or deployed position, lifting one or the other of these flaps and reaching through the opening allows access to individual clubs in either of the two bags without exposing the clubs in the adjacent bag.

Accordingly, the present invention may be characterized in one aspect thereof by a retractable rain cover for a golf cart comprising

a) a fixed frame attachable to a golf cart, the frame having an aft end portion sized to encompass at least an upper end of a golf bag carried on the cart including a section extending below an upper end of the golf bag; and

b) a flexible canopy carried by the frame and movable relative to the frame between a stowed position and a deployed position, the canopy in the deployed position being disposed along the aft end portion and overlying the golf bag.

In another aspect, the present invention may be characterized by a retractable rain cover for a golf cart comprising:

a) a fixed frame attachable to a golf cart, the frame having an aft end portion sized to encompass at least an upper end of a golf bag carried on the cart including a section extending below an upper end of the golf bag;

b) a flexible canopy carried by the frame and movable relative to the frame between a stowed position and a deployed position, the canopy in the deployed position being disposed along the aft end portion and overlying the golf bag; and

c) the canopy having a closable opening and in the extended position the opening being located over and in alignment with the upper end of the golf bag to permit access to any golf club in the bag when the canopy is in the extended position.

### BRIEF DESCRIPTION OF THE SEVERAL VIEWS OF THE DRAWING(S)

FIG. 1 is a perspective view showing one embodiment of a retractable rain cover assembly of the present invention in a retracted position;

FIG. 2 is a view similar to FIG. 1 only showing the assembly in a deployed position;

FIG. 3 is a view on an enlarged scale taken along lines 3-3 of FIG. 2;

FIG. 4 is a rear elevation view showing the assembly of FIG. 2 attached to a golf cart;

FIG. 5 is a side elevation view showing a portion of the golf cart of FIG. 4;

FIGS. 6 and 7 are views similar to FIGS. 1 and 2 respectively only showing another embodiment of a retractable rain cover according to the present invention;

FIG. 8 is a view on an enlarged scale taken along lines 8-8 of FIG. 6; and

FIG. 9 is a bottom perspective view showing the assembly of FIGS. 6 and 7 attached to a golf cart.

FIG. 10A is a perspective view of another embodiment of a retractable rain cover assembly according to another preferred embodiment of the invention.

FIGS. 10B and 10C are cross-sectional views of embodiments of the invention taken along section line A-A in FIG. 10A.

FIG. 11 is a perspective view of yet another embodiment of a retractable rain cover assembly according to another preferred embodiment of the invention.

FIG. 12 is a perspective view of yet another embodiment of a retractable rain cover assembly according to another preferred embodiment of the invention.

### DETAILED DESCRIPTION OF THE INVENTION

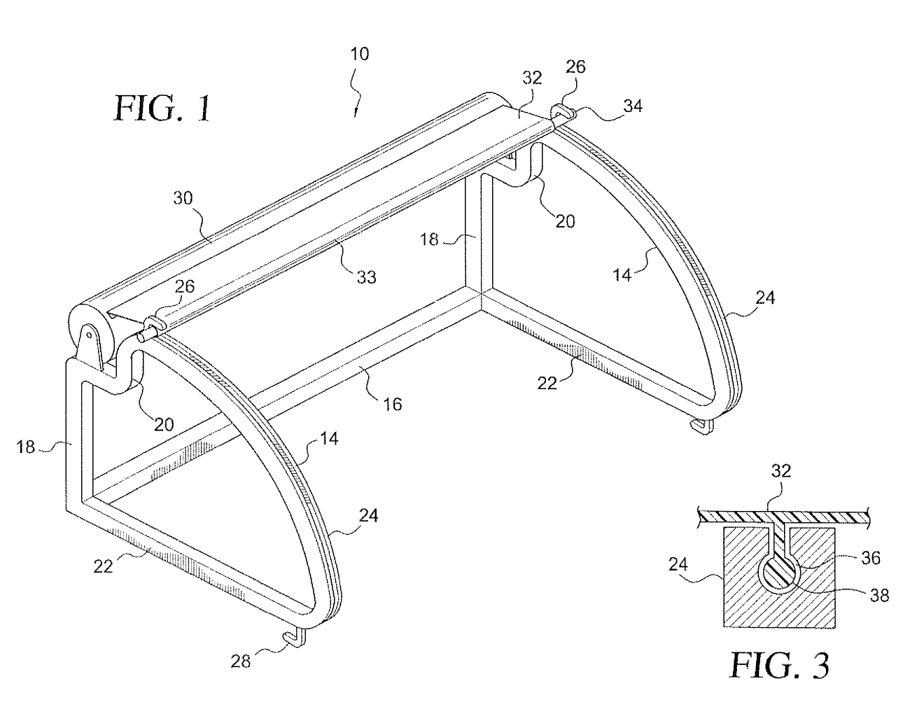

Referring to the drawings, FIG. 1 shows a first embodiment of a retractable rain cover assembly of the present invention generally indicated at 10. The assembly 10 is attachable to a golf cart as further described hereinbelow and includes an open framework having opposite side members 14 and a connecting crosspiece 16. The cross piece is about as long as a golf cart is wide so that the opposite side members 14 are spaced about a golf cart width apart.

The open framework is formed by rigid structural elements wherein each of the side members 14 includes an upright piece 18, a horizontal piece 22 extending out (rearward or in an aft direction) from the bottom of the upright piece and a curved piece 24 that connects the outer end of the horizontal piece to the top of the upright piece at a dogleg 20.

Each curved piece 24 has a rear facing catch 26 near where the curved piece 24 connects to the dogleg 20. A similar, but opposite (forward) facing catch 28 is located preferably on the horizontal piece 22 near where the horizontal and curved pieces 22, 24 connect.

Extending between the side members 14 is a generally cylindrical housing 30. The housing is connected at its ends in the doglegs 20 and contains a rewind reel (not shown). The housing provides storage for a length of a flexible canopy that is wound onto the reel. The canopy, a portion of which is shown at 32, preferably is made of a flexible rain proof or rain repellant material such as canvas, plastic or the like. Preferably the rewind reel in the housing 30 is spring loaded so that when the canopy material is pulled out from the housing, a rewind force is created that tends to retract the canopy into the housing.

The trailing edge (not shown) of the canopy material is fixed within the housing 30 to the rewind reel and the leading edge 33 of the canopy material is attached to a rod 34. The engagement of this rod with the rear facing catch 26 as shown in FIG. 1 prevents the canopy material from being retracted entirely into the housing. This holds the leading edge of the canopy in an accessible position.

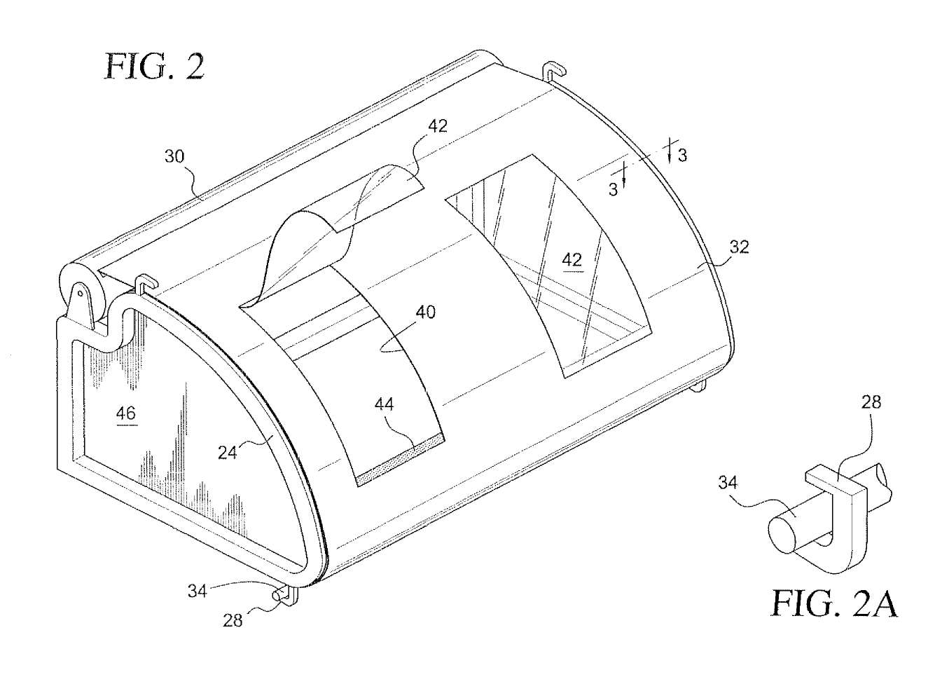

FIG. 2 shows the flexible canopy material 32 in a deployed position. In this respect the canopy material is shown fully extended from the housing 30 with the rod 34 at the forward end of the material being engaged with the forward facing catch 28 (FIG. 2A). In its deployed position the canopy material is shaped by the curved pieces 24. This is due, in part, to the rewind force of the reel within the housing that pulls the canopy material between the housing and the catch 28 taut against the curved piece 24. Accordingly, the canopy material 32, as shown in FIG. 2 conforms to the profile of the opposite side members 14 and is maintained taught by the curved pieces 24.

In addition, or as an alternative method of having the canopy material conform to the shape of the side members, FIG. 3 shows that each of the curved pieces 24 may include a guide channel 36 formed in a curved face of the piece. Disposed in the channel is a bead 38 formed along the lateral edges of the canopy material. With the bead captured in the channel, the canopy material will be drawn along the surface of the curved piece as the material is extended or retracted relative to the housing 30. The engagement of the bead and channel further serves to secure the canopy material to the curved piece. Securing the canopy material to the curved pieces prevents a wind force from lifting the canopy of off the curved pieces.

Referring again to FIG. 2, canopy material 32 is provided with two openings 40. The openings are strategically located (as discussed further hereinbelow) and are closed by a flap 42. Preferably the flap is made of a clear material and is held in a closed position by any suitable quick release fastener 44 such as a snap, zipper or a loop and hook fastener. FIG. 2 further shows that each side member 14 has an attached panel 46 that closes off the sides of the frame. The panel may be held to the side members 14 by any suitable fastener that allows easy removal. The attached panel may be of the same flexible material as the canopy material or of a more rigid character

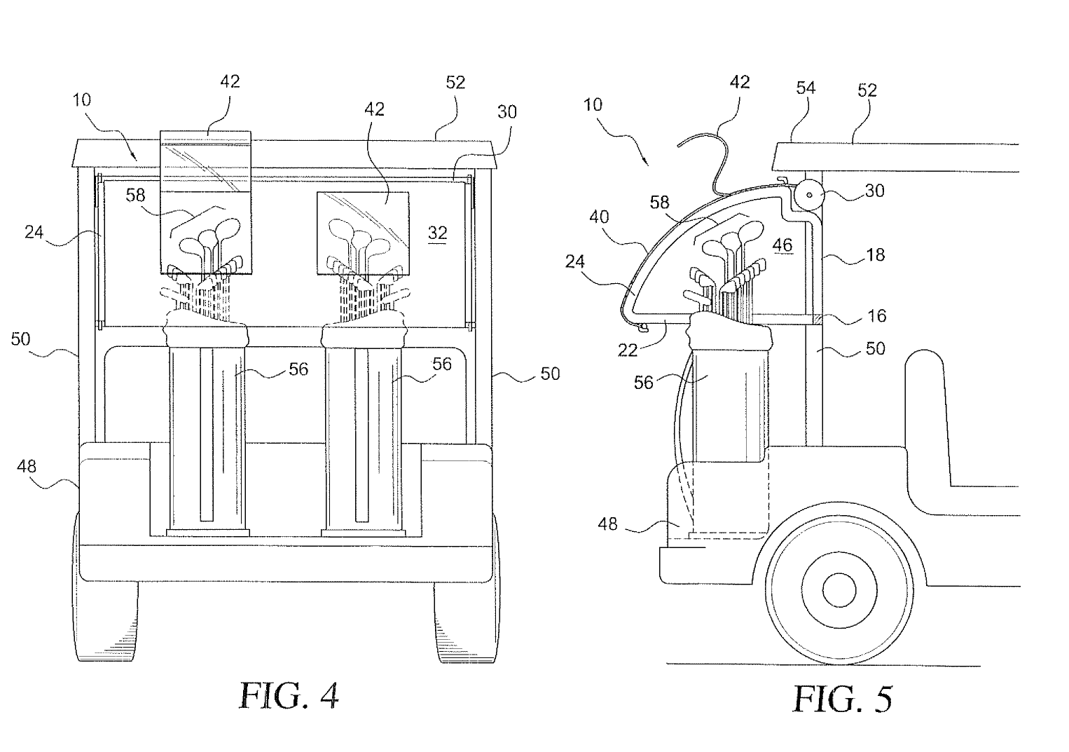

FIGS. 4 and 5 show the retractable rain cover assembly 10 attached to a golf cart 48 and the canopy material in a deployed or extended position to overlie a pair of golf bags 56 carried at the rear of the cart. In this respect the frame upright pieces 18 preferably are attached to support columns 50 that hold up the roof 52 of the golf cart. With this arrangement, the housing 30 extends along the rear roofline 54 of the cart.

The horizontal pieces 22 extend in an aft direction from the golf cart (FIG. 5) and are long enough to extend beyond the golf bags 56. Moreover the horizontal pieces are positioned at an elevation that is well below the upper ends of the golf bags so the curved pieces 24 arch over the golf bags. Thus, as shown in FIGS. 4 and 5, the height, depth and length of the frame as defined by the side members 14 and the length of the cross piece 16 are such that the frame accommodates an upper end of the golf bag 56 carried on the cart.

Since the curved pieces 24 arch over the bags, the heads 58 of the clubs extending from the bag are encompassed by a combination of the deployed canopy material 32 that overlies the club heads and by the side panels 46 that close off the open sides of the frame. In this fashion the club heads are protected from rain.

FIGS. 4 and 5 also show that when the canopy material is deployed, the openings 40 in the canopy are located above each of the golf bags 56. Accordingly, if play continues during a rain shower, individual clubs in either of the bags can be accessed and removed through the openings simply by raising the respective flap 42. Moreover, accessing the clubs in one bag will not expose the clubs in the other.

The canopy material may be deployed as needed and in fair weather, it is simply retracted to a stowed position in the housing 30 as shown in FIG. 1. To stow the canopy material, the rod 34 is released from the catch 28. The canopy material then is moved manually or preferably by a rewind tension back onto the reel within the housing. As the leading edge of the canopy material approaches the housing, the rod 34 is engaged with the catch 26 (FIG. 1).

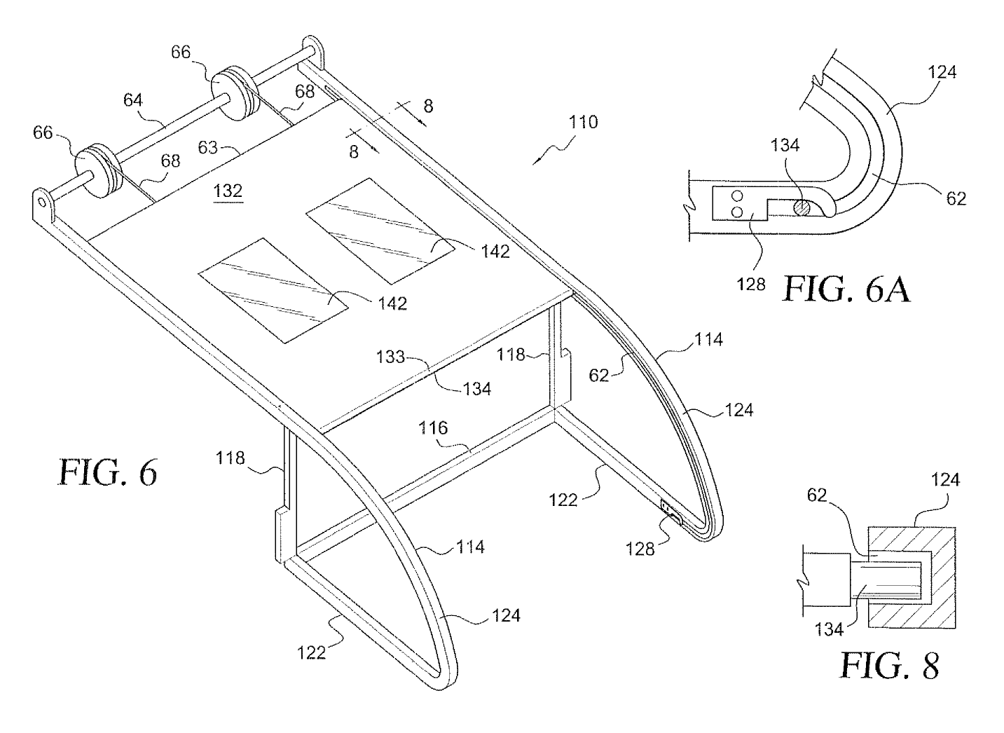

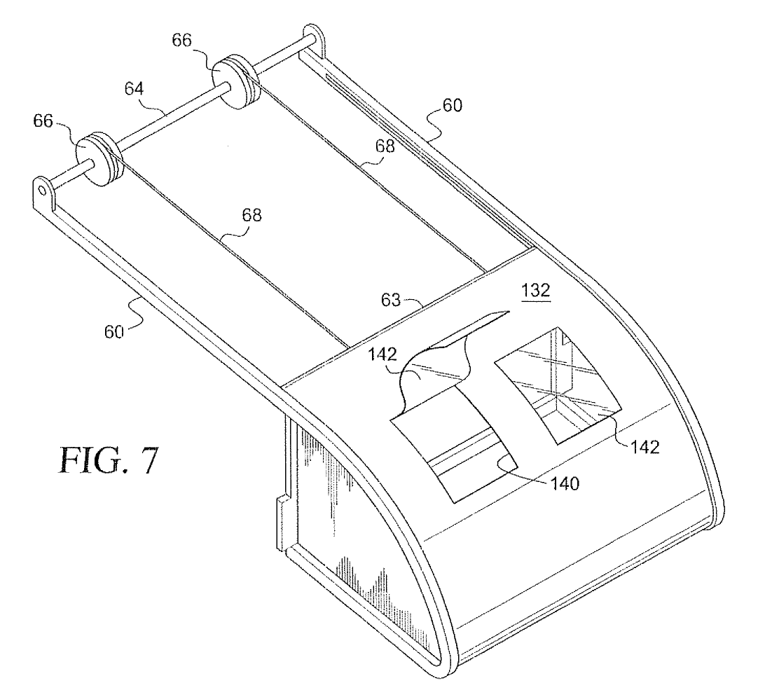

FIGS. 6 and 7 illustrate another embodiment of the invention. In this embodiment, rather than storage on a reel within a housing 30 at the golf cart rear roofline as shown in FIG. 1, the canopy material 132 instead is stored flat and within the footprint of the golf cart roof. Accordingly, as shown in FIG. 6, the retractable rain cover assembly 1 10 comprises an open framework of generally the same size and shape as the open framework of the FIG. 1 embodiment and includes opposite side members 114 connected by a cross piece 116.

The rigid structural elements forming each side member 114 include an upright piece 118, a horizontal piece 122 and a curved piece 124. In this case however, the dogleg connection of the upright piece 118 to the curved piece is missing. Instead there are two rails 60 that attach to or comprise a continuation of each curved piece 124 and extend in a forward direction. Each rail 60 has a channel 62 that continues into the curved piece 124.

At the forward most end of each rail is an axel 64. The axel is journaled at its ends to each of the rails. Fixed to the axel is a pair of spaced pulleys 66. A cord 68 is wound on each pulley, the free end of each cord being attached to a trailing edge 63 of the canopy material 132. Preferably the rotation of the axel 64 (or of the pulleys 66) is biased so there is a rewind force on the chords.

The canopy material 132 lies between the rails and its leading edge is attached to a rod 134. As shown in FIG. 8, the opposite ends of the rod 134 ride in the channels 62. Accordingly and as noted above, the canopy when stowed is flat (rather than rolled) and it lies within the footprint of the roof and substantially parallel to the plane of the roof.

To deploy the canopy material, one simply pulls the rod 134 so the flat canopy moves along the channel 62 out from under the golf cart roof and follows the curved pieces 124 to the position shown in FIG. 7. As the canopy material is deployed, the rewind force on the chords 68 increase so the rod 134 must be latched to hold the canopy in a deployed position.

As shown in FIG. 6, a catch 128 is provided at the lower end of each curved piece 124 adjacent the end of the channel 62. When the canopy material is in a deployed position, the ends of the rod 134 are engaged with the catch as shown in FIG. 6A to hold the canopy material against the rewind bias.

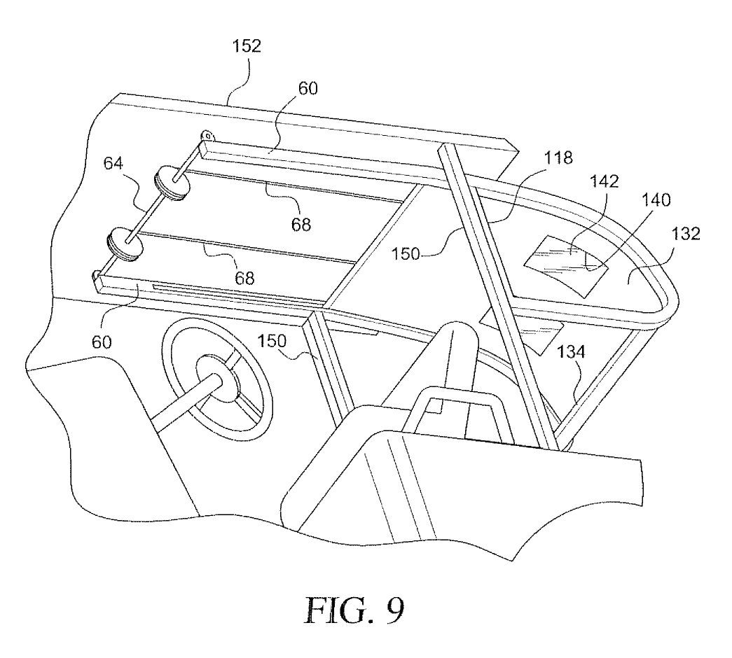

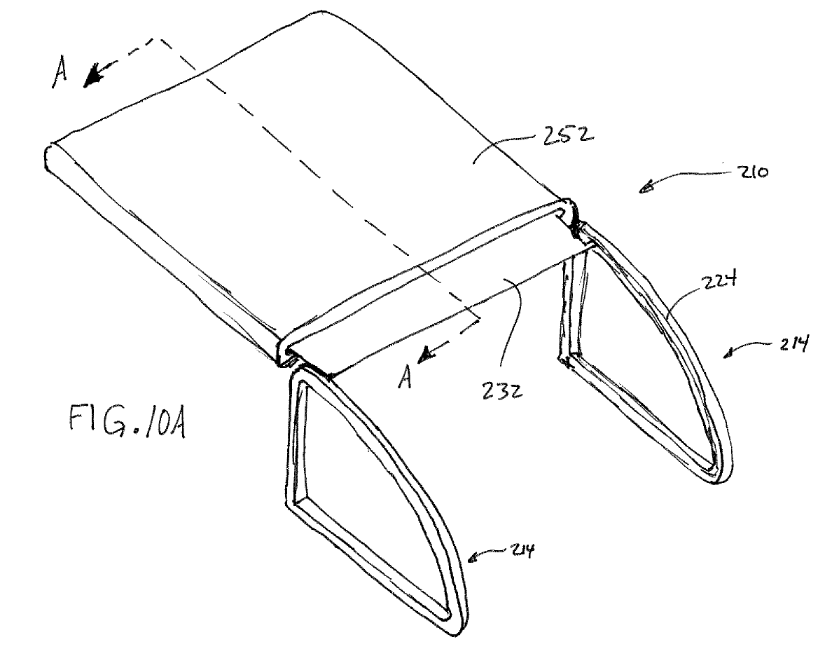

FIG. 9 shows the rain cover assembly of FIGS. 6 and 7 attached to a golf cart with the canopy material deployed. In this respect the side rails 60 are attached to the underside of the golf cart roof 152 and the frame upright pieces 118 are attached to the roof support columns 150. The open framework as defined by the side members 114 and the cross piece 116, like the framework of the FIG. 1 embodiment, is of a size and shape to encompass an upper portion of a golf bag (not shown) carried on the cart. Accordingly, when the canopy material is deployed as shown in FIGS. 7 and 9, the heads of clubs contained in the bag are protected from the rain. Further the appropriate openings 140 and closing flaps 142 are provided to permit access to the clubs when the canopy material is deployed.

To retract the canopy material to a stowed position, the rod 134 is unlatched from the catch 128 to allow a spring bias to rewind the pulleys 66 and reel up the chords 68. This returns the canopy material to its stowed position within the footprint of the golf cart roof.

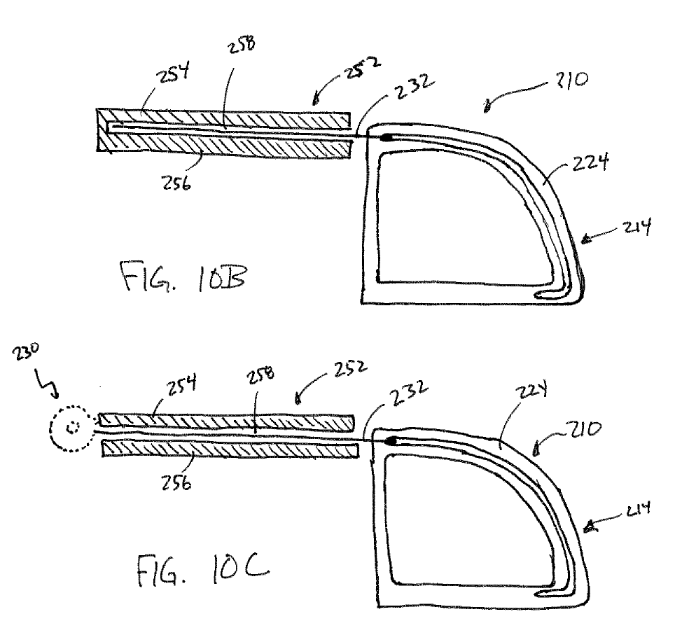

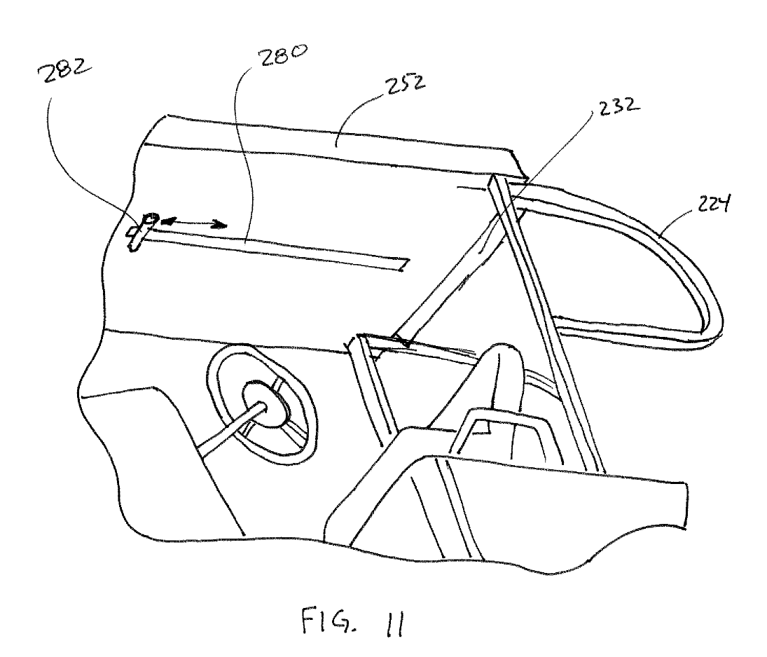

Another preferred embodiment of the invention will now be described with reference to FIGS. 10A-10C. In this embodiment, the golf cart has a roof 252 with a layered construction. More specifically, the roof includes an upper layer 254 and a lower layer 256 defining an opening 258 therebetween. As illustrated in FIGS. 10B and 10C, respectively, the upper and lower layers of the roof may be joined at side edges thereof, or may also be joined at a front edge thereof. In such embodiments, the canopy 232 is substantially contained within the opening 258 of roof 252 when the canopy 232 is in the retracted position, and being pulled out from within the opening 258 deploys the canopy 232 over the golf clubs. Thus, according to this embodiment, the canopy extends over the golf clubs when deployed and is maintained flat between the upper and lower layers 254, 256 of the roof 252 when in the retracted position.

In this embodiment, the retractable rain cover assembly 210 is formed substantially as according to the previously-described embodiments of the invention. More particularly, the assembly 210 preferably includes an open frame including opposite side members 214 having curved pieces 224. Channels may be formed in the curved pieces similar to those shown in FIG. 3 or FIG. 6A for receiving opposite ends of a rod (not shown) or the like attached to the canopy, e.g., the leading edge of the canopy. Channels alternatively may be formed on outer or lower faces of the curved pieces 224 with mating mechanisms being attached to the canopy and riding within the channels.

The assembly 210 according to this invention also may have a cylindrical housing 230 (shown in phantom in FIG. 10C) disposed proximate a front end of the roof 252. The cylindrical housing functions in substantially the same manner as the cylindrical housing 30 described above with reference to FIG. 1, namely, to attach to the trailing edge of the canopy and in which the canopy is stored when moved to the stowed position. Alternatively, and to limit the amount of material necessary to make the canopy 232, the assembly 210 may include one or more pulleys such as those illustrated by reference numeral 66 in FIGS. 6 and 7. The pulleys preferably are disposed proximate the front end of the roof, with the cords attaching the canopy to the pulleys substantially disposed within the opening 258 of the roof. Two pulleys having co-linear, substantially horizontal axes of rotation may be used in this embodiment similar to the configuration illustrated in FIGS. 6 and 7. If the opening 258 defined by the upper and lower layers to the root is large enough, the pulleys (or the cylindrical housing also may be disposed within the opening 258 of the roof 252 so as to maintain the same footprint of the roof and to shield the components from the elements. To facilitate placement of the pulleys within the opening, the pulleys may be disposed such that their respective axes of rotation are substantially vertical. In addition, one or both of the upper and lower layers of the roof also may include cutouts to facilitate placement of the pulleys within the footprint of the roof.

In each of these just-described configurations, the pulleys or the cylindrical housing preferably have an inherent bias to return the canopy to the stowed position. For example, the pulleys or housing may be spring-loaded or reverse-biased to bias the canopy into the opening of the roof. In use, a user standing behind the golf cart grasps the leading edge of the canopy and pulls the canopy to a deployed position with sufficient force to overcome the inherent bias. One or more catches similar to those used in the embodiment described with reference to FIG. 1 may be used to maintain the canopy in the deployed position.

In the deployed position, the canopy is substantially in the same position as illustrated in FIGS. 2, 5, and 7. The canopy preferably also includes closeable openings similar to those described above with reference to FIGS. 2, 5, and 7. Thus, when the canopy is in the deployed position, the openings preferably are disposed above the golf bags, for selective access to the golf clubs without stowing the canopy. Of course, one relatively large opening may be used in place of two separate openings, the one opening being sized and positioned to allow access to both golf bags simultaneously.

When the canopy is no longer needed, the user preferably unlatches the leading edge of the canopy and the is returned to the stowed position. Preferably, the leading edge of the canopy is prohibited from entering the opening 258 in the stowed position. To this end, a catch may be used to inhibit motion of the canopy in a direction toward the stowing position beyond a predetermined position, the position being proximate to or contacting the rear edge of the roof. Although the invention has been described as employing a return bias for biasing the canopy to a stowed position, such is not necessary. For example, the user may have to manually manipulate the canopy into the stowed position. Or, automatic means, such as a motor or the like may be used to extend and retract the canopy.

A channel or the like also may be formed in the roof to guide the canopy as it is deployed from and retracted into the opening 258 in the roof 252. Preferably, two channels are formed on facing inner surfaces of the sides of the roof, the channels facing the opening 258. A mating bead or similar structure is disposed on the canopy and received within the channel to maintain the canopy in communication with the channel. One will appreciate that such a configuration may alleviate the need for the cylindrical housing and/or the pulley(s) and may, for example, be particularly well-suited with a roof such as that illustrated in FIG. 10B. More specifically, in this embodiment, sides of the canopy proximate the trailing end of the canopy preferably are captured in the channels with the trailing edge being substantially free or floating within the opening. The channels preferably do not extend out the back of the roof, such that a stop is created to disallow complete removal of the canopy from within the roof. If the material comprising the canopy is sufficiently rigid, a user standing behind the golf cart may easily pull the canopy into the deployed position, or push the canopy into the stowed position. In this embodiment, channels also preferably are provided in the curved pieces, such as those illustrated in and discussed with regard to FIGS. 3 and 6A, to maintain orientation of the canopy.

Other mechanisms, such as pressure rollers, guides, and the like also may be used to maintain the orientation of the canopy within the opening, and/or to prevent bunching or misalignment of the canopy. Such bunching or misalignment may also be more likely with a more flexible canopy.

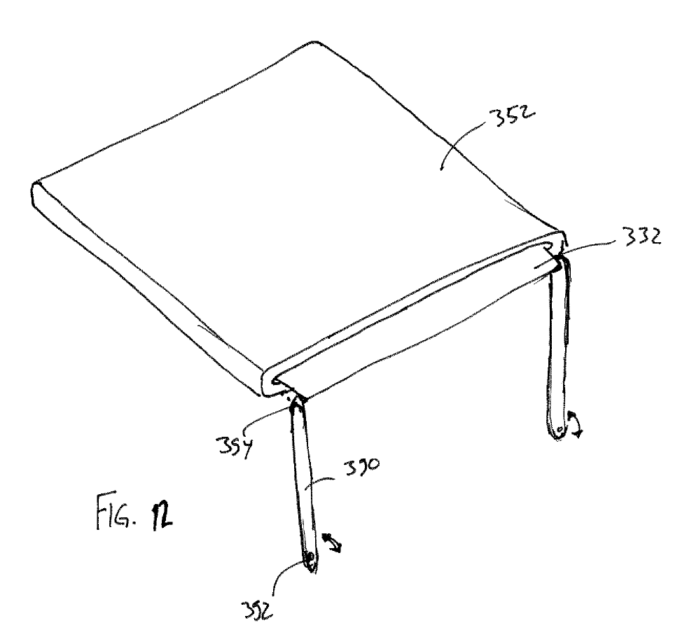

Another configuration for effectuating stowing and deployment of the canopy 232 is illustrated in FIG. 11. In this embodiment a slot 280 is formed through the lower layer of the roof, and a handle 282 is disposed within the slot, fixed to the canopy. A user grasps the handle 282 and moves the handle 282 within the slot 280. Because the handle is fixed to the canopy, movement of the handle causes a corresponding movement of the canopy, i.e., between the stowed and deployed positions. In this manner, it is possible to cover one's clubs in inclement weather without getting out of the cart. Similarly, the slot may be formed on one or both sides of the roof, with the handle being disposed in communication with the canopy through the slot(s). As should be understood in this embodiment, when the handle is attached proximate the trailing end of the canopy, a more rigid canopy may be preferred to avoid bunching of the canopy upon deployment. Of course, this preferred configuration also allows deployment of the canopy by standing behind the golf cart and pulling the canopy from the stowed position.

Another embodiment of the invention now will be described with reference to FIG. 12. As illustrated therein, a roof 352 has a layered structure, similar to that shown in FIGS. 10A-10C and 11. In this embodiment, the curved pieces are replaced with articulating arms 390. Each of the articulating arms is pivotable about a first end 392, attached to the golf cart at a distance from the opening 358 in the roof 352. The canopy 332, proximate a leading end, is coupled to the second end 394 of each of the articulating arms. The arms articulate about their first end 352 from the substantially vertical position illustrated in FIG. 12, i.e., the stowed position, through some angle to the deployed position. In the deployed position, the canopy 332 covers golf bags placed on the cart. The canopy 332 preferably includes closeable openings such as those shown in previous embodiments, aligned with the golf bags. A catch, clasp, fastener, or the like preferably is employed to maintain the canopy in the deployed position. Methods for biasing the canopy to the stowed position, such as those described in detail above, also may be used in this embodiment.

The invention has been described with reference to a number of preferred embodiments. As should be appreciated by one of ordinary skill in the art, features of each of the embodiments may be used in other embodiments to perform similar functions. Numerous combinations of the components and features described above will be readily ascertained from the foregoing description of the invention, and each of these combinations and variations is understood to be a part of the invention.

Accordingly, it should be appreciated that the present invention accomplishes its intended objects in providing a retractable rain cover attachable to the roof of a golf cart wherein the rain cover is easily deployed in inclement weather and is retracted as easily as it is deployed. When in the deployed position, the rain cover allows separate access to adjacent golf bags so the clubs in one bag need not be exposed to the rain when selecting a club from another bag.

1. A retractable rain cover for attachment to a golf cart, the golf cart having a roof including upper and lower layers defining an opening therebetween and a rear end portion adapted to support at least two side-by-side upright golf bags, the rain cover comprising:
a rigid open frame attachable to a rear of the golf cart and comprising two side members, one located on each side of the rear end portion of the golf cart;
a canopy carried by and extending between the two side members, the canopy being movable between a stowed position between upper and lower layers of the roof and a deployed position supported by the two side members of the frame, the canopy in the deployed position overlaying the upper ends of the two side-by-side upright golf bags; and
at least one closable opening within the canopy located to align with the upper end of at least one of the two side-by-side upright golf bags when the canopy is in the deployed position.

2. The retractable rain cover according to claim 1, wherein the stowed position of the canopy is a rolled up position extending along a front roof line of the golf cart.

3. The retractable rain cover according to claim 2, further comprising an elongate housing attached to the frame along a front roof line of the golf cart, wherein the canopy in its rolled up stowed position being at least partially disposed in the housing.

4. The retractable rain cover according to claim 1, wherein the stowed position of the canopy is a lay flat position in the opening of the roof.

5. The retractable rain cover according to claim 1, further comprising at least one rewind reel and a cord extending from the reel to a trailing edge of the canopy.

6. The retractable rain cover according to claim S, wherein the at least one rewind reel and the cord are disposed within the opening defined by the upper and lower layers of the roof.

7. A retractable rain cover assembly for use with a golf cart having a rear end portion adapted to support at least two side-by-side upright golf bags, the assembly comprising:
a roof comprising an upper layer and a lower layer, the upper layer and lower layer defining an opening there between; and
a canopy disposed at least partially in the opening, the canopy movable between a deployed position in which the canopy overlays the upper ends of the two side-by-side upright golf bags and a stowed position in which the canopy is substantially contained within the opening between the upper layer and the lower layer of the roof.

8. The assembly according to claim 7, further comprising a rigid open frame attachable to a rear of the golf cart and comprising two side members, one located on each side of the rear end portion of the golf cart, the two side members supporting the canopy in the deployed position.

9. The assembly according to claim 8, wherein the two side members comprise a channel and sides of the canopy situated proximate to the side members are contained within the channel.

10. The assembly according to claim 6, further comprising at least one closable opening formed through the canopy, the at least one closable opening being aligned with a top of at least one of the side-by-side upright golf bags when the canopy is in the deployed position.

11. The assembly according to claim 6, further comprising a channel formed in the opening of the roof, the channel containing therein a side of the canopy situated proximate thereto.

12. The assembly according to claim 6, further comprising a housing, and the canopy in the stowed position being at least partially disposed in a roll in the housing.

13. The assembly according to claim 12, wherein the canopy in the deployed position is biased toward the stowed position.

14. The assembly according to claim 13, further comprising a catch and a rod attached to a leading edge of the canopy, the catch and the rod engageable when the canopy is in the deployed position to prevent movement of the canopy toward the stowed position.

15. The assembly according to claim 7, wherein the canopy and the stowed position lies within the footprint of the golf cart roof.

16. The assembly according to claim 7, including bias means urging the canopy towards the stowed position, the bias means comprising at least one rewind reel and a cord wound on the reel, the cord having a free end attached to a trailing edge of the canopy material.

17. The assembly according to claim 16, wherein the rewind reel is disposed proximate a front edge of the roof.

18. The assembly according to claim 16, wherein the rewind reel is disposed within the opening defined between the upper layer and the lower layer of the roof.

19. The assembly according to claim 7, further comprising a handle in communication with the canopy, the handle being actuated by a user to selectively move the canopy between the stowed and deployed positions.

20. The assembly according to claim 19, further comprising a slot formed in a portion of the roof, the handle being received and movable within the slot to selectively move the canopy between the stowed and deployed positions.
